(19) United States
(12) Patent Application Publication
(10) Pub. No.: US 2007/0236944 A1
(43) Pub. Date: Oct. 11, 2007

(54) LIGHT DIFFUSER PLATE

(76) Inventors: Shen-Yin Tsai, Tainan City (TW); Hsi-Hsin Shih, Taichung City (TW); Shih-Kai Cheng, Yi Lan City (TW)

Correspondence Address: CHRISTIE, PARKER & HALE, LLP, PO BOX 7068, PASADENA, CA, 91109-7068, US

(21) Appl. No.: 11/696,171

(22) Filed: Apr. 3, 2007

(30) Foreign Application Priority Data
Apr. 10, 2006 (TW) 095112706

(51) Int. Cl. F21V 11/00

(52) U.S. Cl. 362/355

(57) ABSTRACT

A light diffuser plate includes an optical matrix having opposite first and second ends that are opposite to each other in a first direction, alight incident surface, and a light exit surface opposite to the light incident surface in a second direction transverse to the first direction. The optical matrix is formed with a plurality of elongate holes, each of which extends through the first and second ends and each of which has a cross-section transverse to the length thereof. The cross-section of each of the holes has a periphery that has at least a curved segment which extends curvedly.

### CROSS-REFERENCE TO RELATED APPLICATION

This application claims priority of Taiwanese Application No. 095112706, filed on Apr. 10, 2006.

### BACKGROUND OF THE INVENTION

1. Field of the Invention

This invention relates to a light diffuser plate, more particularly to a light diffuser plate formed with a plurality of elongate holes.

2. Description of the Related Art

A backlight module is one of the key components for making a liquid crystal display, and serves to provide a uniform light source for enabling the display of an image on a liquid crystal panel. Based on the disposition of the light source, backlight modules can be classified into a bottom lighting type and a side lighting type. The bottom lighting type normally includes a diffuser plate and optical elements, such as diffusing sheets and brightness-enhancing sheets, for enhancing the uniformity and brightness of the light emerging from the diffuser plate. Conventional diffuser plates are normally formed of a polymer matrix and light scattering particles dispersed in the polymer matrix for scattering light passing therethrough, thereby achieving a light diffusing effect. However, the light scattering particles can absorb a significant portion of the energy of the light passing through the diffuser plate, which results in a decrease in the intensity of the light emerging from the diffuser plate and undesired shifting in color.

### SUMMARY OF THE INVENTION

Therefore, the object of the present invention is to provide a light diffuser plate that can overcome the aforesaid drawback of the prior art.

According to this invention, there is provided a light diffuser plate that comprises an optical matrix having opposite first and second ends that are opposite to each other in a first direction, a light incident surface, and a light exit surface opposite to the light incident surface in a second direction transverse to the first direction. The optical matrix is formed with a plurality of elongate holes, each of which extends through the first and second ends and each of which has a cross-section transverse to the length thereof. The cross-section of each of the holes has a periphery that has at least a curved segment which extends curvedly.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a perspective view of the first preferred embodiment of a light diffuser plate according to this invention;

FIG. 2 is a sectional view to illustrate the light scattering effect imparted by curved surfaces formed in the preferred embodiment;

FIG. 3 is a sectional view of the second preferred embodiment of the light diffuser plate according to this invention;

FIG. 4 is a sectional view of the third preferred embodiment of the light diffuser plate according to this invention;

FIG. 5 is a sectional view of the fourth preferred embodiment of the light diffuser plate according to this invention;

FIG. 6 is a sectional view of the fifth preferred embodiment of the light diffuser plate according to this invention;

FIG. 7 is a sectional view of the sixth preferred embodiment of the light diffuser plate according to this invention; and

FIG. 8 is sectional view of the seventh preferred embodiment of the light diffuser plate according to this invention.

### DETAILED DESCRIPTION OF THE PREFERRED EMBODIMENTS

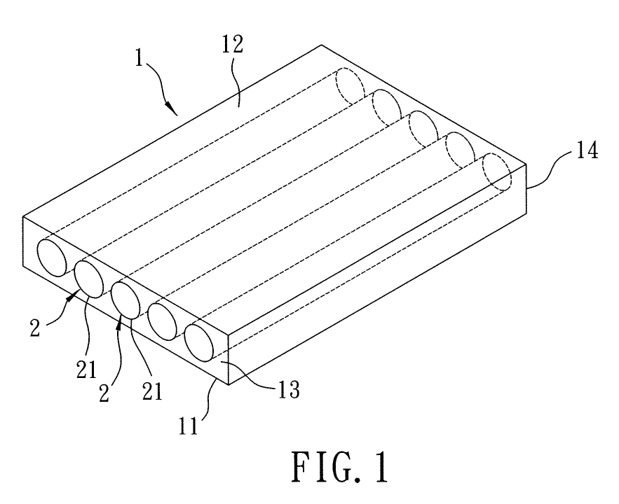

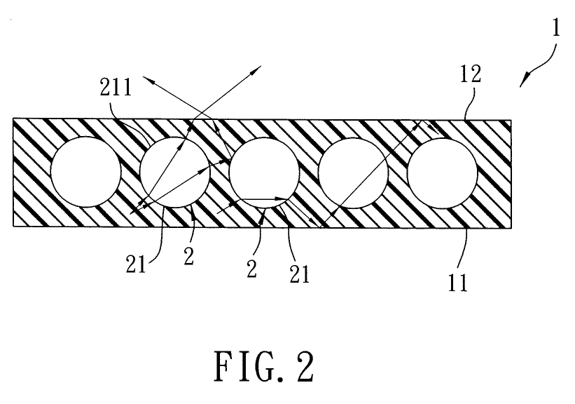

FIGS. 1 and 2 illustrate the first preferred embodiment of a light diffuser plate according to this invention for a backlight module.

The light diffuser plate includes an optical matrix 1 having opposite first and second ends 13, 14 that are opposite to each other in a first direction, a light incident surface 11, and a light exit surface 12 opposite to the light incident surface 11 in a second direction transverse to the first direction. The optical matrix 1 is formed with a plurality of elongate holes 2, each of which extends through the first and second ends 13, 14 and each of which has a cross-section transverse to the length thereof. The cross-section of each of the holes 2 has a periphery 21 that has at least a curved segment 211 which extends curvedly. In this embodiment, the entire periphery 21 of the cross-section of each of the holes 21 is curved and is circular in shape. The optical matrix 1 is made from a transparent polymer material selected from the group consisting of polymethylmethacrylate, polycarbonate, polymethylmethacrylate styrene copolymer, metallocene cycloolefin copolymer, polystyrene, and polymethylpentene. The light diffuser plate is formed by extrusion or compression molding techniques in a conventional manner.

Preferably, the optical matrix 1 has a thickness ranging from 1 mm to 10 mm, and each of the holes 2 has a diameter ranging 0.1 mm to 9.5 mm. The holes 2 in the optical matrix 1 are preferably disposed parallel to each other.

In use, light passes through the light incident surface 11 and into the optical matrix 1 and enters into and then leaves the holes 2, which cause refraction and scattering of the light.

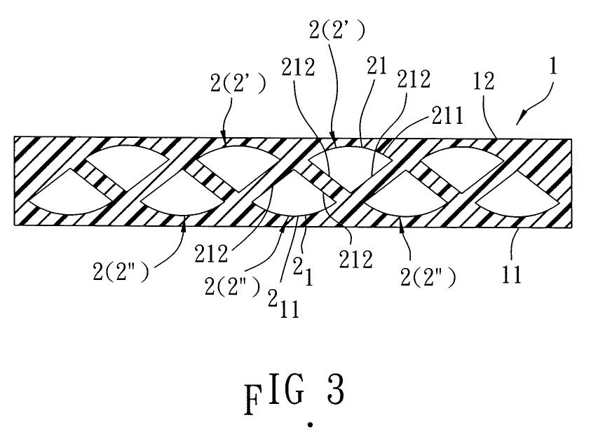

FIG. 3 illustrates the second preferred embodiment of the light diffuser plate according to this invention. The second preferred embodiment differs from the previous embodiment in that the periphery 21 of the cross-section of each of the holes 2 in the optical matrix 1 is sector-shaped. In this embodiment, the holes 2 are divided into aligned first holes 2′ and aligned second holes 2″ that are alternately disposed with the first holes 2′. The cross-section of each of the first holes 2′ and the cross-section of each of the second holes 2″ are inverted in shape. The periphery 21 of the cross-section of each of the first and second holes 2′, 2″ further has two radial segments 212 connected to the curved segment 211. The radial segments 212 of the periphery 21 of the cross-section of each of the first holes 2′ are disposed between and confront respectively an adjacent pair of the radial segments 212 of the peripheries 21 of the cross-sections of an adjacent pair of the second holes 2″.

Alternatively, the periphery 21 of the cross-section of each of the holes 2 in the optical matrix 1 may be elliptic or irregular in shape.

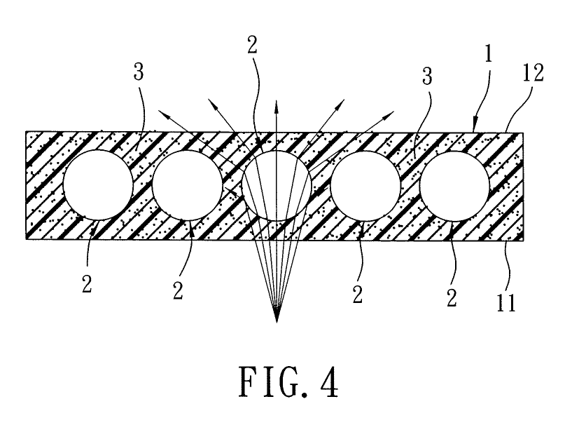

FIG. 4 illustrates the third preferred embodiment of the light diffuser plate according to this invention. The third preferred embodiment differs from the first preferred embodiment in that the optical matrix 1 is formed of the polymer material and light-scattering particles 3 dispersed in the polymer material and having a refractive index different from that of the polymer material for enhancing the light scattering effect. Preferably, the light-scattering particles 3 are present in an amount ranging from 0.05 wt % to 30 wt % based on the total weight of the optical matrix 1, and have a particle diameter ranging from 1 μm to 100 μm. Suitable materials for the light-scattering particles 3 include polycarbonate and acrylic.

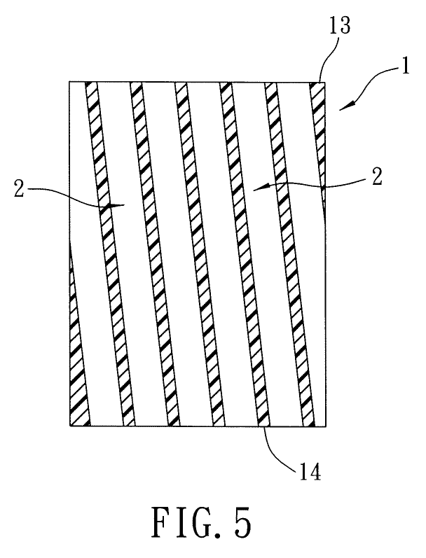

FIG. 5 illustrates the fourth preferred embodiment of the light diffuser plate according to this invention. The fourth preferred embodiment differs from the first preferred embodiment in that the holes 2 are disposed at an inclined angle relative to the first and second ends 13, 14 of the optical matrix 1.

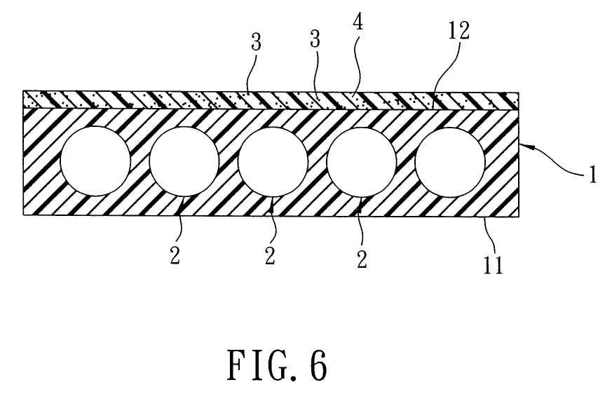

FIG. 6 illustrates the fifth preferred embodiment of the light diffuser plate according to this invention. The fifth preferred embodiment differs from the first preferred embodiment in that it further includes a diffusion-enhancing film 4 formed on the light exit surface 12 of the optical matrix 1. The diffusion-enhancing film 4 is preferably formed of a polymer material and light-scattering particles 3 dispersed in the polymer material. Formation of the diffusion-enhancing film 4 can be conducted by coating the polymer material together with the light-scattering particles 3 on the light exit surface 12 of the optical matrix 1 by spinning or rolling coating techniques or die coating techniques. Note that the diffusion-enhancing film 4 can also be integrally and simultaneously formed with the optical matrix 1.

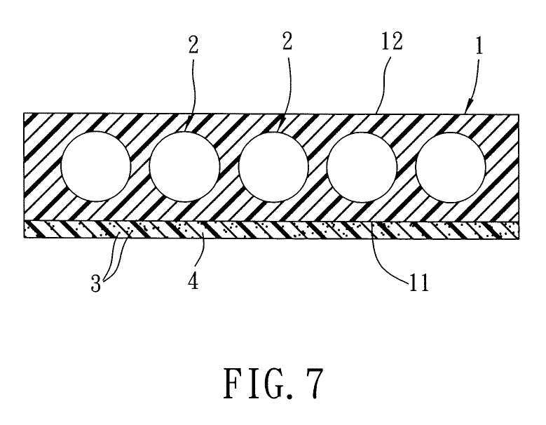

FIG. 7 illustrates the sixth preferred embodiment of the light diffuser plate according to this invention. The sixth preferred embodiment differs from the fifth preferred embodiment in that the diffusion-enhancing film 4 is formed on the light incident surface 11 of the optical matrix 1.

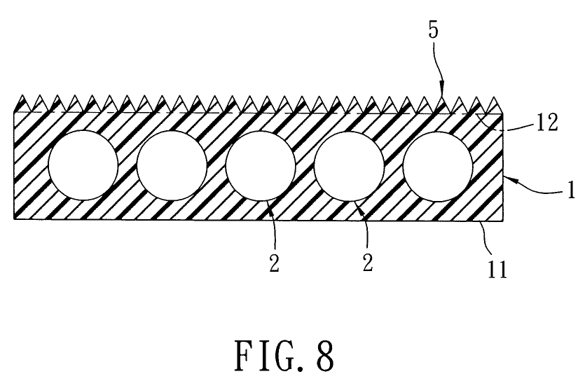

FIG. 8 illustrates the seventh preferred embodiment of the light diffuser plate according to this invention. The seventh preferred embodiment differs from the first preferred embodiment in that the light exit surface 12 of the optical matrix 1 can be roughened by forming a plurality of prismatic protrusions 5 thereon so as to concentrate light passing therethrough and thereby enhance the intensity of the light emerging from the light exit surface 12 of the optical matrix 1. Alternatively, the protrusions 5 may be cylindrical, semi-spherical, or rectangular in shape.

With the inclusion of the holes 2 in the optical matrix 1 of the light diffuser plate of this invention, the aforesaid drawback associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A light diffuser plate comprising:
an optical matrix having opposite first and second ends that are opposite to each other in a first direction, a light incident surface, and a light exit surface opposite to said light incident surface in a second direction transverse to said first direction, said optical matrix being formed with a plurality of elongate holes, each of which extends through said first and second ends and each of which has a cross-section transverse to the length thereof, said cross-section of each of said holes having a periphery that has at least a curved segment which extends curvedly.

2. The light diffuser plate of claim 1, wherein said holes in said optical matrix are disposed parallel to each other.

3. The light diffuser plate of claim 1, wherein said periphery of said cross-section of each of said holes in said optical matrix is circular in shape.

4. The light diffuser plate of claim 1, wherein said periphery of said cross-section of each of said holes in said optical matrix is sector-shaped.

5. The light diffuser plate of claim 4, wherein said holes are divided into aligned first holes and aligned second holes that are alternately disposed with said first holes, said cross-section of each of said first holes and said cross-section of each of said second holes being inverted in shape.

6. The light diffuser plate of claim 5, wherein said periphery of said cross-section of each of said first and second holes further has two radial segments connected to said curved segment, said radial segments of said periphery of said cross-section of each of said first holes being disposed between and confronting respectively an adjacent pair of said radial segments of said peripheries of said cross-sections of an adjacent pair of said second holes.

7. The light diffuser plate of claim 1, wherein said optical matrix has a thickness ranging from 1 mm to 10 mm.

8. The light diffuser plate of claim 3, wherein each of said holes has a diameter ranging 0.1 mm to 9.5 mm.

9. The light diffuser plate of claim 1, wherein said optical matrix is formed of a polymer material and light-scattering particles dispersed in said polymer material and having a refractive index different from that of said polymer material.

10. The light diffuser plate of claim 9, wherein said polymer material is selected from the group consisting of polymethylmethacrylate, polycarbonate, polymethylmethacrylate styrene copolymer, metallocene cycloolefin copolymer, polystyrene, and polymethylpentene.

11. The light diffuser plate of claim 9, wherein said light-scattering particles are present in an amount ranging from 0.05 wt % to 30 wt % based on the total weight of said optical matrix.

12. The light diffuser plate of claim 9, wherein said light-scattering particles have a particle diameter ranging from 1 μm to 100 μm.

13. The light diffuser plate of claim 1, further comprising a diffusion-enhancing film formed on said optical matrix and formed of a polymer material and light-scattering particles dispersed in said polymer material.

14. The light diffuser plate of claim 1, wherein said light exit surface of said optical matrix is formed with a plurality of prismatic protrusions thereon.
